(19) United States
(12) Patent Application Publication
(10) Pub. No.: US 2022/0350920 A1
(43) Pub. Date: Nov. 3, 2022

(54) SENSITIVE MEDIA USAGE

(71) Applicant: Hewlett-Packard Development Company, L.P., Spring, TX (US)

(72) Inventors: Dilip Rathnakar, Bangalore (IN); Viswanatha Shankaranarayana, Bangalore (IN); Rajdhar Kumar, Bangalore (IN); Dhanasekhar Kolamala, Bangalore (IN)

(73) Assignee: Hewlett-Packard Development Company, L.P., Spring, TX (US)

(21) Appl. No.: 17/267,249

(22) PCT Filed: Sep. 16, 2019
(86) PCT No.: PCT/US2019/051315

§ 371 Date: Feb. 9, 2021

(30) Foreign Application Priority Data
Nov. 16, 2018 (IN) IN201841043198

(51) Int. Cl. G06F 21/62; G06F 21/60; G06F 21/33

(52) U.S. Cl. CPC G06F 21/6245; G06F 21/608; G06F 21/33

(57) ABSTRACT

There is provided a method and apparatus to restrict user access to sensitive media in a rendering apparatus, comprising providing a secure media tray having an electronic lock operated by firmware, providing a print job to the rendering apparatus, validating user credentials to confirm a user is authorised to access the sensitive media, obtaining an authorisation code from the user, validating the authorisation code, and printing the print job using media from the secure media tray.

### BACKGROUND

The present disclosure relates to the control of sensitive media usage in a shared environment. Shared resources include printers that many users can access and as such there is a risk of fraudulent use of shared resources.

### BRIEF DESCRIPTION OF THE DRAWINGS

Various features and advantages of certain examples will be apparent from the detailed description which follows, taken in conjunction with the accompanying drawings, which together illustrate, by way of example only, a number of features, and wherein:

FIG. 1 shows a method to restrict user access to sensitive media in a rendering apparatus according to an example;

FIG. 2 shows a method to restrict user access to sensitive media in a rendering apparatus according to an example;

FIG. 3 shows a flow diagram for physically securing access to sensitive media in a printer input bin according to an example;

FIG. 4 shows a method for controlling the usage of sensitive media stored in a secure input bin according to an example;

FIG. 5 shows a method for controlling the usage of sensitive media stored in a secure input bin according to an example;

FIG. 6 shows a method for controlling the usage of sensitive media stored in a secure input bin according to an example;

FIG. 7 shows a method for controlling the usage of sensitive media stored in a secure input bin according to an example;

FIG. 8 shows a rendering apparatus according to an example; and

FIG. 9 shows an example of a processor associated with a memory for performing a method for controlling usage of sensitive media stored in a secure input bin according to an example.

### DETAILED DESCRIPTION

In the following description, for purposes of explanation numerous specific details of certain examples are set forth. Reference in the specification to “an example” or similar language means that a particular feature, structure, or characteristic described in connection with the example is included in at least that one example, but not necessarily in other examples.

Shared resources such as printers pose a threat of misuse of sensitive media due to unrestricted access to printer input trays into which sensitive media can be loaded.

The disclosure relates to physically securing input bins with sensitive media from unauthorized users. Tracking of sensitive prints on this media throughout its life span can be provided. There is provided a method for the securing of sensitive media while loaded in an input tray.

Organizations print, critical documents on letterheads. The printouts on letterheads that bear the company's logo are often deemed as official documents and have a legal standing. Hence the usage of letterheads is restricted in most organizations. Organizations, especially in the government, use sensitive papers such as judicial papers or those with certain watermarks for printing confidential material or documents with legal binding. The content of the printouts from such media would be of sensitive nature. For instance, HR personnel may print job contracts with salary details for new employees or promotion/hike letters. The marketing department may print marketing orders or bid contracts with sensitive pricing details. The finance department may print tax bills or account receipts. Universities or schools may print certificates, marks sheets and question papers for students on sensitive media. A company's legal cell may print a plethora of legal documents. All of these examples can use official letterheads. The documents printed would also be confidential and of a legally sensitive nature.

Many of business establishments have shared printers. Office staff from multiple departments may use a common printer in the floor. When the printer is a shared one, and certain departments loading sensitive media into the printer, there is a risk of unauthorized people picking up this kind of restricted media from the printer input bins or media trays. This poses a serious threat of misuse of such media. For example, personnel are exposed to the risks of misuse of sensitive media by loading the printer input bin with the sensitive media and walking away to their desk to send the print job, which provides a good opportunity for theft of unguarded media. Further, leaving behind unused and excess sensitive media in input trays could also lead to its unlawful usage.

The disclosure provides a system which prevents unauthorized access to secure input bins of a printer with sensitive media. The system physically secures the access to the sensitive media in the printer input bin using electronically operated locks and sensors. The system controls the usage of the sensitive media stored in the secured input bins using encrypted key, Personal. Identification Number (PIN) printing, digital certificate/signature or authorization agents. The system tracks the prints form designated sensitive input bins. Therefore, there is provided a solution to secure unused sensitive media from being misused. The input bins are physically secured to prevent the sensitive media from being picked up from input bins. Access to the sensitive media is secured by restricting the usage of the sensitive media while printing jobs. Access to sensitive media is tracked to detect any fraud or misuse.

There is provided a method and apparatus for (i) physically securing access to sensitive media in printer input bins; (ii) controlling the usage of sensitive media stored in secure input bins; and (iii) tracking the prints from designated sensitive media input bins, i.e. tracking users and the documents/sensitive media that are printed.

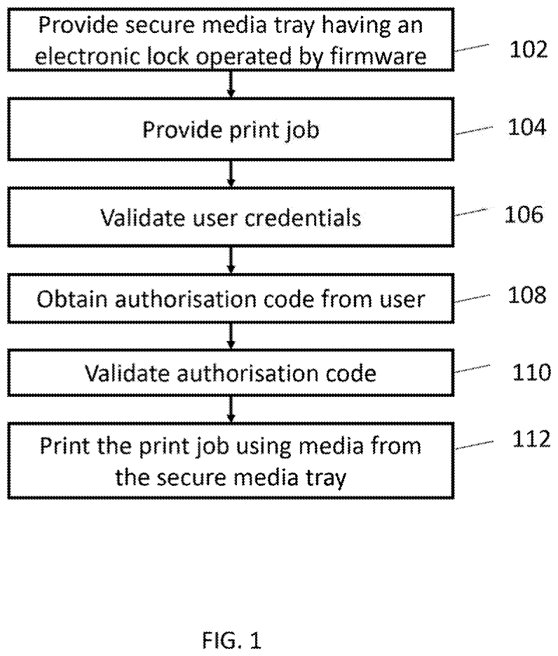

FIG. 1 shows a method to restrict user access to sensitive media in a rendering apparatus according to an example. Sensitive media is considered to relate to media such as company letterheads, judicial papers, or papers with watermarks used to print sensitive information or legal documents. At block 102 a secure media tray having an electronic lock operated by firmware is provided. A secure input bin relates to an input tray or bin of a rendering apparatus or printer that is dedicated for the usage of sensitive media and hence made secure. At block 104 a print job is provided to the rendering apparatus. The print job may be a sensitive print job to be printed on sensitive media where the job is of a sensitive nature. At block 106 user credentials are validated to confirm that the user is authorised to access the sensitive media. An authorized or privileged user refers to a user who has the permission to operate the secure input bin and send sensitive jobs. At block 108 an authorisation code is obtained from the user. According to an example, the authorisation code may be one of a: private key; PIN; and digital certificate. At block 110 the authorisation code is validated. At block 112 the print job is rendered or printed using media from the secure media tray.

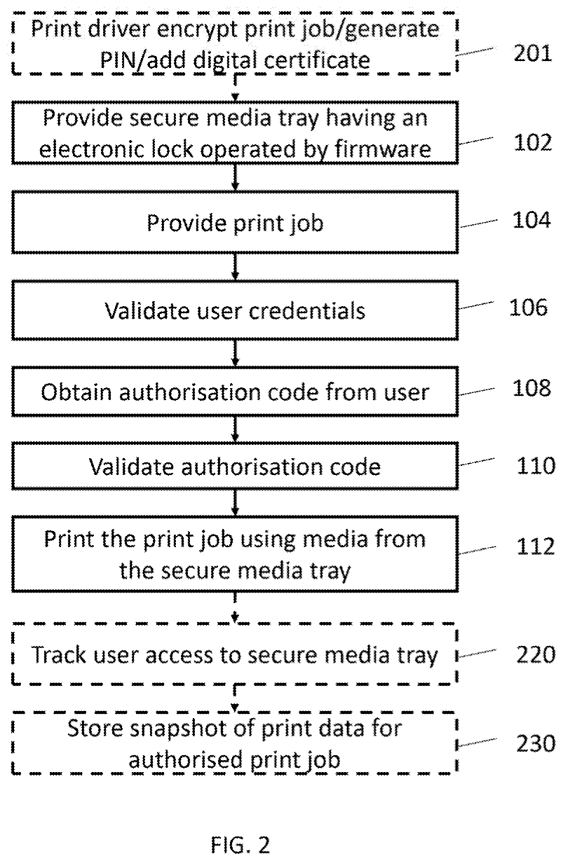

FIG. 2 shows a method to restrict user access to sensitive media in a rendering apparatus according to an example. At block 201 the print job may be provided to the rendering apparatus through a print driver. According to an example, the print driver can encrypt the print job at the print driver with a private key. The user may then enter the private key at the rendering apparatus and decrypt the print job using the private key. According to an example, the print driver may generate a PIN. According to an example, the print driver may add a digital certificate to the print job before providing the signed print job to the rendering apparatus. According to an example, the user may load the print job onto the rendering apparatus from a portable storage device, such as a USB stick.

According to an example, the prints from the designated sensitive input bins may be tracked. At block 220 user access to the secure media tray may be tracked. For example, any job that is printed using media from a secure input bin can be tracked (e.g. “track and trace”). Printers may participate in block-chains or use secure-in premises logging for trackability. Whenever secure input bins are involved, “track and trace” may be automatically invoked.

At block 230 a snapshot of the printed document may be saved in encrypted format, which could be used for any forensic investigations later. A snapshot of the print data related to the authorised print job may be stored in a memory.

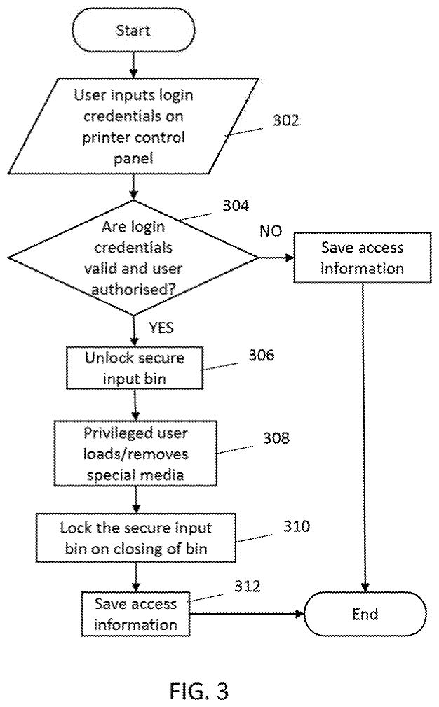

FIG. 3 shows a flow diagram for physically securing access to sensitive media in a printer input bin according to an example. In this example, access to sensitive media loaded in the secure input bin is restricted to sensitive print jobs to be printed from the secure input bin for authenticated users, i.e. authorized users with privileges are allowed to print on media from the secure input bin. The sensitive media can be secured when it is loaded into the printer input bin. A printer may have multiple input bins, where one or more of those input bins can be reserved to handle the sensitive media.

According to an example, an input bin reserved for sensitive media comprises electronically operated locks controlled via printer firmware, i.e. the secure input bin can be locked physically through electronically operated locks that are controlled through firmware. Access to the secure input bin can then be provided to authorized users. The secure input bin may comprise sensors that detect the loading and/or unloading of media from the secure input bin, for example via a weight sensor or proximity sensor.

At block 302 the user can enter their credentials, for example in the printer front panel menu. At block 304 the printer firmware validates the entered user credentials. If the user is an authorized one, the firmware releases the lock of the secure input bin at block 306. After unlocking the tray, the privileged user is granted access to the secure media tray. At block 308 the authorised user is able to then load/unload sensitive or secure media into the secure media tray. Once the user closes the secure media tray the printer firmware engages the locking system at block 310. For example, sensors may detect when the user has opened/closed the secure media tray. Once the tray gets locked, the sensitive media in the input bin gets secured from theft. Sensors in the secure input bin may detect if media has been either loaded or removed. At the end of this operation sequence the following data is available which may be saved at block 312: details of the user who has operated the secure input bin; date and time of operation; printer serial number; and the kind of operation performed, i.e., loading or unloading media. As such, this operation sequence of unlocking of the secure input bin and loading/unloading of media can be tracked. Records that contain meta data that includes the u identity, date and time of operation, printer identity/serial number, and any such useful information can be created.

According to an example, sensors in the input bins could be used to detect the nature of the operation, i.e., loading or unloading media from the secure input bin. The same could be used for tracking purpose. For example, inbuilt scanners and/or OCR controllers in the printing device could be activated to fingerprint or take a snapshot of the media loaded. This can help to know what kind of sensitive media the user loaded. The information which is recorded would be helpful for tracking employees who have accessed media in any of the common shared printers.

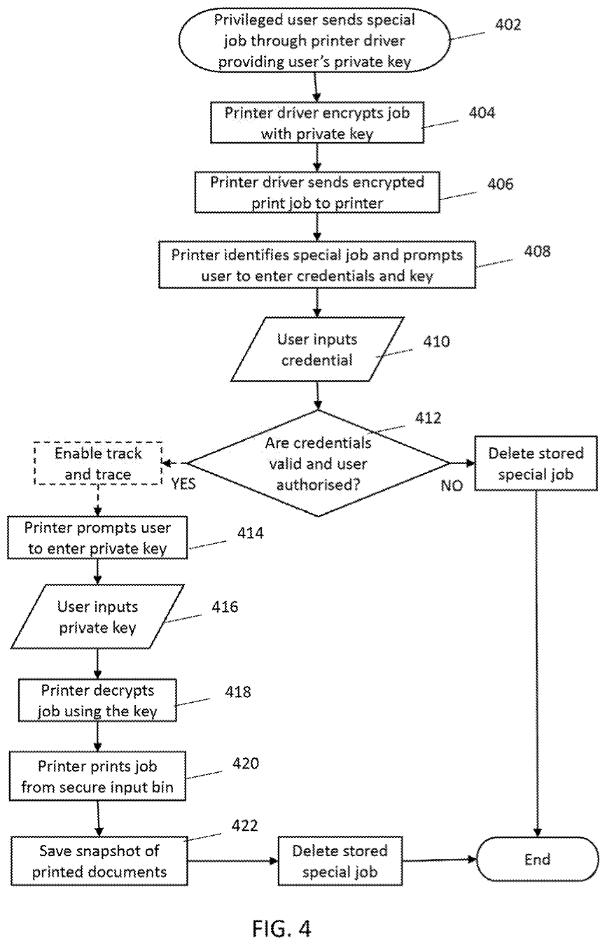

FIG. 4 shows a method for controlling the usage of sensitive media stored in a secure input bin according to an example. The access of sensitive media loaded in the secure input bin may be restricted through management of print jobs. For example, sensitive print jobs to be printed from the secure input bin can be user authenticated. Authorized users with privileges are allowed to print on media from the secure input bin. Print jobs from the secure input bin may be managed as follows. At block 402 the authorized user uses their private key known to them to encrypt the print job before sending the job to the printer. The authorized user provides the private key to the printer driver while choosing the sensitive job to be printed. At block 404 the printer driver encrypts the sensitive job with the user's private key. At block 406 the printer driver sends the encrypted job to the printer. At block 408 the printer receives the sensitive job and saves it like a stored job. The printer identifies the sensitive job and prompts the user to enter their credentials (and private key). At block 410 the user enters the credentials which may be via the printer front panel. At block 412 the printer firmware then validates the user. If the user is not validated the stored sensitive job may be deleted. If the user is validated the printer prompts the user to enter their private key at block 414. At block 416 the user enters their private key. At block 418 upon successful validation the printer uses the same key to decrypt the stored job. At block 420 the printer prints the job using media from the secure input bin. At block 422 a snapshot of the print job may be saved into memory and may comprise encrypted meta data.

According to an example, if the user is not authorised to print using the secure input bin, the user can be allowed to print from a non-secure media tray.

“Track and trace” technology can be used to track and trace documents printed from any printer and also detect manipulations done on printed documents. It also collects data such as the identity of the user who printed, the date and time of print, the printer on which the document was printed, print protocol used for printing, the IP address from where the print job was sent, details of the network and so on. The same could be leveraged here. Whenever secure input bins are involved, “track and trace” could be automatically invoked.

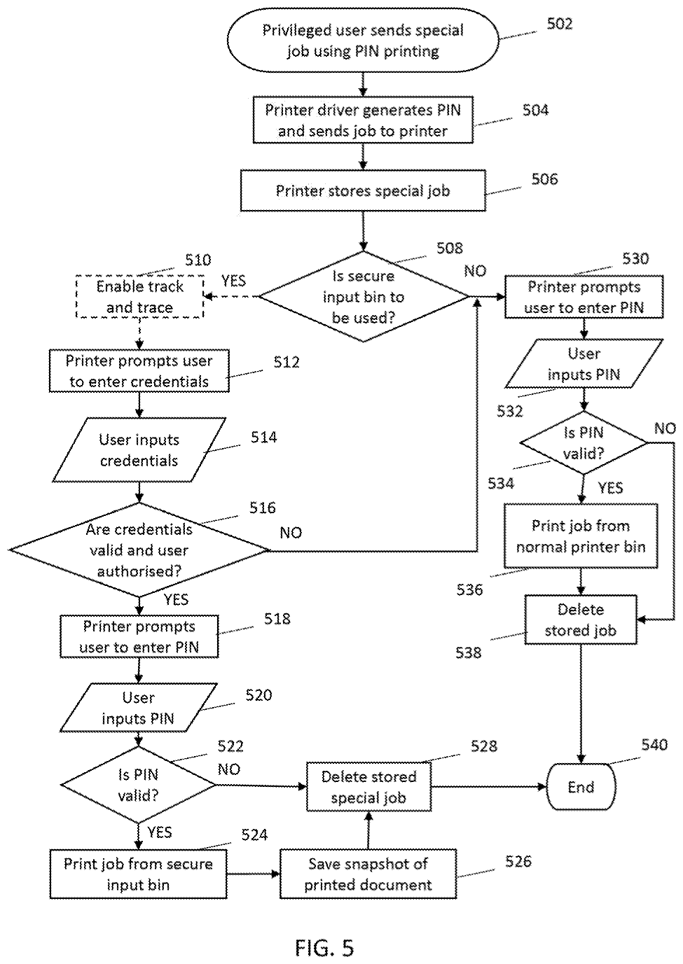

FIG. 5 shows a method for controlling the usage of sensitive media stored in a secure input bin according to an example. Personal Identification Number (PIN) based printing and/or walk-up printing can be used to help achieve printouts not being left unattended since the user is at the printer when the print jobs are processed. A stored job may be printed using PIN based printing. For example, an existing PIN printing workflow can be leveraged. At block 502 a privileged user sends a print job which may be a sensitive print job. At block 504 the printer driver generates a one-time usable PIN and notifies the user and sends the print job to the printer. At block 506 the printer upon receiving this job stores it like a normal stored job. At block 508 the printer determines if the print job is a sensitive print job and whether or not a secure input bin is to be used. At block 510 a track and trace may be enabled by the printer. At block 512 the printer prompts the user to enter their credentials for authorisation to print from the secure input bin. At block 514 the privileged user inputs their credentials to authenticate themselves with valid credentials from the printer control panel. Upon validation at block 516, the user is provided with an option in the front panel menu to select the secure input bin and enter the one-time PIN that is connected to the print job at block 518. At block 520 the user enters the PIN. At block 522 the printer validates the PIN. At block 524 upon successful validation the printer uses media from the secure input bin to print the print job, i.e. the stored job gets printed from the media stacked in the secure bin. A snapshot of the printed document may be saved at block 526. The stored print job is deleted at block 528. At block 508 if the print job is a not a sensitive print job but instead is a print job, the secure input bin is not used. Similarly, at block 516 if the user credentials are incorrect or are not valid such that the user is not authorised to print on media from the secure input bin, the secure input bin is not used. At block 530 the printer prompts the user to enter the PIN associated with the print job. At block 532 the user enters the PIN. At block 534 the printer checks whether the PIN is valid and if successfully validated, at block 536 the printer prints the print job from a normal input bin (i.e. not a secure input bin). At block 538 the stored job is deleted. According to an example, if the user is not authorised to print using the secure input bin, the user can be allowed to print from a non-secure media tray. The workflow is ended at block 540.

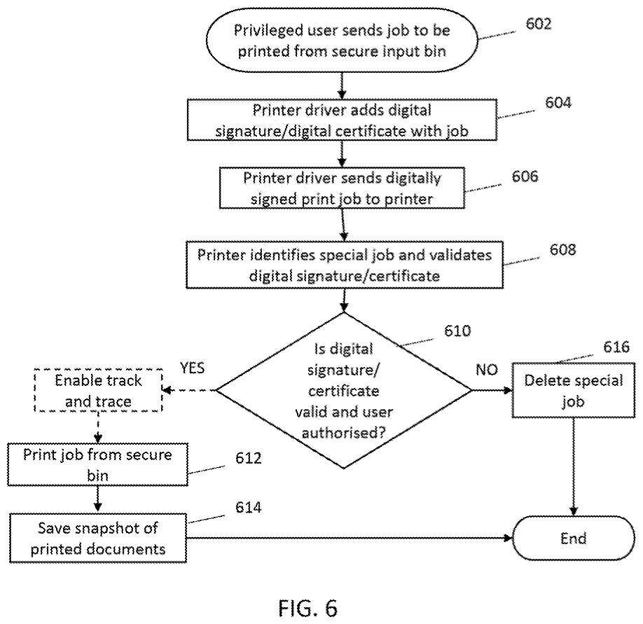

FIG. 6 shows a method for controlling the usage of sensitive media stored in a secure input bin according to an example. At block 602 a sensitive print job is sent by a privileged user to be printed from a secure input bin. At block 604 the printer driver adds a digital signature or digital certificate such that the print job will carry a digital signature or digital certificate. For example, print jobs that have the option to associate themselves with a digital signature, like IPP (Internet Print Protocol) could be used for digital authentication and authorization. The sensitive job sent by the privileged user will carry a digital signature or a digital certificate. At block 606 the printer drivers send the signed print job to the printer. At block 608 the printer identifies the sensitive print job and the printer firmware validates the user with the digital signature associated with the print job. If the certificate is valid and the user is authorised the printer prints the sensitive print job using media from the secure input bin at block 612. A snapshot of the printed document may be saved at block 614. If the certificate is not valid or the user is not authorised the printer will delete the sensitive print job at block 616. According to an example, if the user is not authorised to, print using the secure input bin, the user can be allowed to print from a non-secure media tray.

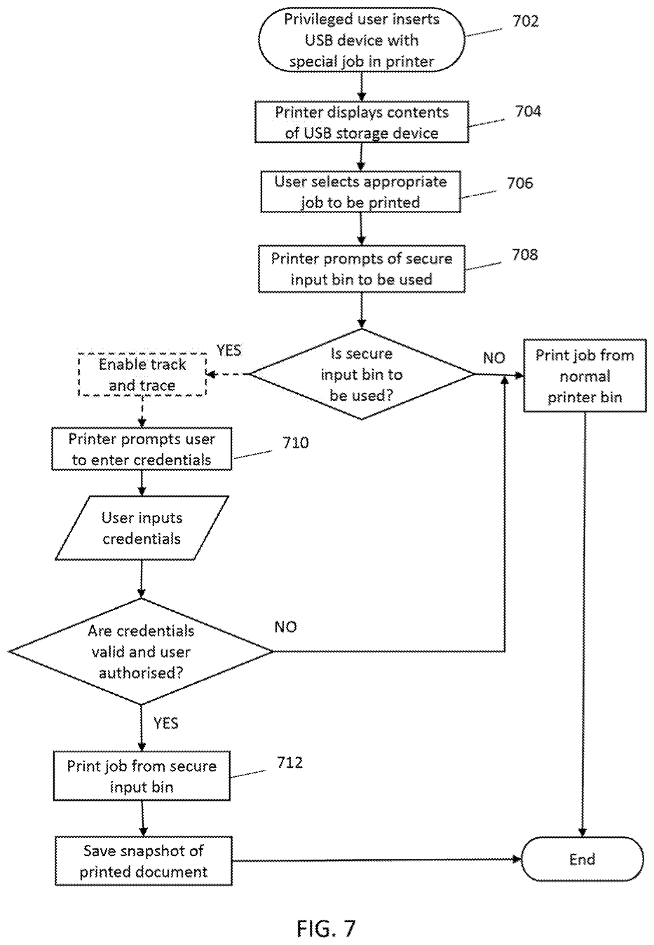

FIG. 7 shows a method for controlling the sage of sensitive media stored in a secure input bin according to an example. When an authorized user wants to print a file stored in a USB storage device, at block 702 the user inserts the device into the printer. At block 704 the printer then reads and displays the contents of the device. At block 706 the user selects the file to be printed. At block 708 the printer then prompts the user to specify the media onto which the job is to be printed and whether the media is from the secure input bin. If yes, the user is prompted at block 710 to enter his credentials. Upon successful validation, the printer prints the job from the secured bin at block 712. If an unauthorized user accidentally selects any of the sensitive bins, the printer may be configured to prompt the user to choose a different bin or the selection can itself be automated for unauthorized users. According to an example, if the user is not authorised to print using the secure input bin, the user can be allowed to print from a non-secure media tray.

According to an example, UPD/Drivers can be enhanced to pass the authorization information like Kerberos tickets or OAUTH cookie. Alternatively, Universal Print Drivers (UPD) or discrete drivers may be enhanced to pass the authorization information like Kerberos tickets or OAUTH cookie. The printer can validate this with the preconfigured authorization agent and allow the jobs to be printed.

According to an example, a user can obtain a photo-copy of a document at a shared printer or multi-functional product having a secure input bin loaded with sensitive media. A multi-functional product may support fax, photo-copy and print having a secure input bin or media tray loaded with sensitive media (locked input tray). The user is permitted to take a photo-copy using the sensitive media if the user is authorised. The authorised user can provide their credentials for authorisation. If the user is not an authorised user and does not have permission to use the sensitive media, the job can be redirected to another media tray or input bin loaded with normal media. According to an example, a printing device having a secure input bin with sensitive media may receive a fax and not be permitted to use sensitive media to print the incoming fax.

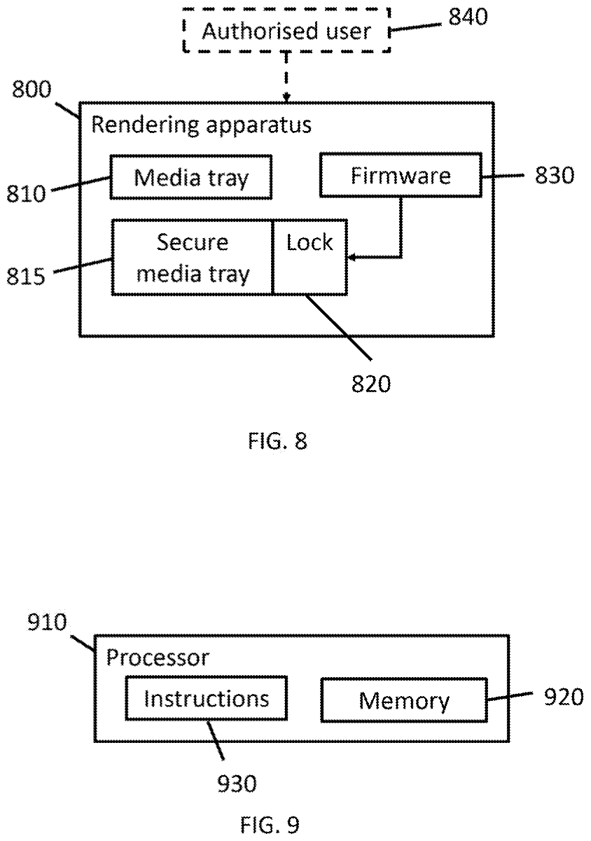

FIG. 8 shows a rendering apparatus according to an example. The apparatus 800 comprises a plurality of media trays 810, 815. At least one media tray is a secure media tray 815 for handling sensitive media. An electronic lock 820 operated via firmware 830 is configured to permit access to the secure media tray 815 upon validation of a request for access from an authorised user 840. The electronic lock permits authorised access or denies unauthorised access to the secure input bins and sensitive media. Sensitive print jobs are linked to authorised users for access to sensitive media. For example, an authorised user may be issued with an access tag by an administrator. According to an example, a rendering apparatus may comprise a plurality of secure media trays wherein each tray may comprise a different type of sensitive media and/or a different user group(s).

The apparatus nay comprise a processor configured to track the use of sensitive media, for example via meta data linked to authorised users. Sensors may be provided on the secure media tray. Whenever an authorised user accesses the secure media tray the processor may be configured to create a new record and store the record in a blockchain (for example). As such, the locking and unlocking of the secure media tray is monitored and each time sensitive media is loaded or unloaded at the secure media tray there is a record of that activity. A snapshot of the printed document may be recorded using a scanner linked to the secure media tray. For example, inbuilt scanners and OCR controllers in the device could be activated to fingerprint or take snapshot of the media loaded which would help to know what kind of media was loaded by the authorized user. Print data may be encrypted before being saved in a record. The snapshot of the printed document can be saved in an encrypted format. This would help to know what was printed by the user. This data would facilitate any forensic investigation in case of a fraud.

The tracking of prints from secure input bins monitors the usage of sensitive media and help achieve restricted access by authorized users. Tracking is useful where privileged users misuse sensitive media and where a fraud occurs, forensic data can aid any investigation.

The method and apparatus provided remove cumbersome procedures and workflows to secure and restrict the usage of sensitive media. For example, the burden of staff to “guard” media or the concerned authorities is removed whilst controlling sensitive media usage. Shared resources can be maintained instead of providing one or more dedicated printers to privileged or authorised users. Unused media is protected by firmware controlled electronic locks on the secure media trays to physically secure the media and prevent the media from being picked up from the input bins. The access to sensitive media is secured by restricting the usage of the media while printing jobs, for example to restrict an amount or quota of sensitive media to an authorised user which may be linked to a print job and/or duration (week/month etc.). The access to sensitive media and its usage can be tracked, generating sufficient data to investigate cases of fraud or misuse. For example, frauds may print a blank document to gain access to the sensitive media or print illegal data or false data. The snapshots collected can provide vital data for investigation. Availability of forensic data would also act as a deterrent to frauds. The methods described can help achieve the presence of the user at the printer when the printout is being generated from the secure input bin. For example, the user can walk up to the printer to enter the encryption key and user credentials to help achieve the user's presence when the job is printed which secures the printout from theft.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor for restricting user access to sensitive media in a rendering apparatus.

FIG. 9 shows an example of a processor 910 associated with a memory 920. The memory 920 comprises computer readable instructions 930 which are executable by the processor 910 to restrict user access to sensitive media in a rendering apparatus. The instructions 930 comprise:

Instructions to provide a secure media tray having an electronic lock operated by firmware;
Instructions to provide a print job to the rendering apparatus;
Instructions to validate user credentials to confirm a user is authorised to access the sensitive media;
Instructions to obtain an authorisation code from the user;
Instructions to validate the authorisation code; and
Instructions to print the print job using media from the secure media tray.

Such machine-readable instructions may also be loaded onto a computer or other programmable data processing devices, so that the computer or other programmable data processing devices perform a series of operations to produce computer-implemented processing, thus the instructions executed on, the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method to restrict user access to sensitive media in a rendering apparatus, comprising:
providing a secure media tray having an electronic lock operated by firmware;
providing a print job to the rendering apparatus;
validating user credentials to confirm a user is authorised to access the sensitive media;
obtaining an authorisation code from the user;
validating the authorisation code; and
printing the print job using media from the secure media tray.

2. A method according to claim 1, wherein the authorisation code is one of a: private key; PIN; and digital certificate.

3. A method according to claim 2, comprising providing the print job to the rendering apparatus through a print driver.

4. A method according to claim 3, comprising encrypting the print job at the print driver with a private key.

5. A method according to claim 4, comprising the user entering the private key at the rendering apparatus and decrypting the print job using the private key.

6. A method according to claim 3, comprising the print driver generating a PIN.

7. A method according to claim 3, comprising the print driver adding a digital certificate to the print job before providing the signed print job to the rendering apparatus.

8. A method according to claim 1, comprising the user loading the print job onto the rendering apparatus from a portable storage device.

9. A method according to claim 1, comprising controlling the electronic lock on the secure media tray to allow the user physical access to the secure media tray.

10. A method according to claim 1, comprising tracking user access to the secure media tray.

11. A method according to claim 1, comprising storing a snapshot of print data related to the authorised print job in a memory.

12. A rendering apparatus, comprising:
a plurality of media trays, wherein at least one media tray is a secure media tray for handling sensitive media; and
an electronic lock operated via firmware and configured to permit access to the secure media tray upon validation of a request for access from an authorised user.

13. An apparatus according to claim 12, further comprising a processor configured to track use of the sensitive media from the secure media tray.

14. An apparatus according to claim 12, further comprising sensors on the secure media tray configured to detect media being loaded or unloaded from the secure media tray.

15. A non-transitory machine-readable storage medium encoded with instructions executable by a processor for restricting user access to sensitive media in a rendering apparatus, the machine-readable storage medium comprising instructions to:
operate a firmware controlled electronic lock on a secure media tray;
provide a print job to the rendering apparatus;
validate user credentials to confirm a user is authorised to access the sensitive media;
obtain an authorisation code from the user;
validate the authorisation code; and
print the print job using media from the secure media tray.
